(19) United States
(12) Patent Application Publication
(10) Pub. No.: US 2019/0084213 A1
(43) Pub. Date: Mar. 21, 2019

(54) RESIN MOLDING METHOD AND RESIN MOLDING DEVICE

(71) Applicant: HONDA MOTOR CO., LTD., Tokyo (JP)

(72) Inventors: Yasushi Arahata, Tochigi (JP); Chiriki Watanabe, Tochigi (JP); Koji Watanabe, Tochigi (JP); Hisashi Masuda, Tochigi (JP)

(21) Appl. No.: 15/758,809

(22) PCT Filed: Sep. 13, 2016
(86) PCT No.: PCT/JP2016/076912

§ 371 Date: Mar. 9, 2018

(30) Foreign Application Priority Data
Sep. 17, 2015 (JP) 2015-184421
Sep. 17, 2015 (JP) 2015-184422

(51) Int. Cl. B29C 51/04; B29C 51/10; B29C 51/12; B29C 51/26

(52) U.S. Cl. CPC B29C 51/04; B29C 51/10; B29C 51/42; B29C 51/262; B29C 51/12

(57) ABSTRACT

A resin sheet material 2 in a state of being stretched in a longitudinal direction is held by a stretching and bending mechanism 3, and heated and softened by a heating unit 5. The softened resin sheet material 2 is stretched by pulling the ends in the longitudinal direction and ends in a transverse direction of the resin sheet material by the stretching and bending mechanism 3. The stretched resin sheet material 2 is bent by the stretching and bending mechanism 3, and molded by vacuum forming by a resin molding unit 6.

### TECHNICAL FIELD

The present invention relates to a resin molding method and a resin molding device for vacuum forming or pressure forming a resin sheet material.

### BACKGROUND ART

Conventionally, as a method of forming a skin of an instrument panel of an automobile by molding a resin sheet material, there is known a method in which, after heating a resin sheet material, the resin sheet material is stretched, and bonded to a base material of the instrument panel while performing vacuum forming (see, for example, Patent Literature 1).

According to the method of Patent Literature 1, the resin sheet material is held by a skin clamp device, and heated and stretched. Then, a vacuum suction mold on the base material side on which the base material of the instrument panel is mounted, is raised to a predetermined position with respect to the resin sheet material inclined at a predetermined inclination angle with respect to the horizontal plane, and thereby a portion of the base material is covered with a portion of the resin sheet material.

Next, by lowering a vacuum suction mold on the skin side and pressing the remaining portions of the resin sheet material against the base material, the remaining portions of the base material are covered with the remaining portions of the resin sheet material. Thereafter, by performing clamping and applying suction from the vacuum suction mold on the skin side, a predetermined surface shape is molded in the resin sheet material.

After stopping the suction, when the resin sheet material is sucked up through a ventilation section of the base material from the vacuum suction mold on the base material side, the resin sheet material is bonded to the base material through an adhesive on the back surface thereof. In this way, the skin made of the resin sheet material is formed on the surface of the base material.

### CITATION LIST

### Patent Literature

Patent Literature 1: Japanese Patent No. 5617796

### SUMMARY OF INVENTION

### Technical Problem

However, according to the above-described conventional technique, when the resin sheet material held by the skin clamp device is heated, drawdown that is sagging down of the softened resin sheet material occurs. In molding of the resin sheet material, the drawdown causes wrinkles and tears in a formed part of the resin sheet material.

Further, according to the above conventional technique, when the resin sheet material is pressed against the base material of the instrument panel by the vacuum suction mold on the base material side and the vacuum suction mold on the skin side for covering, the resin sheet material is first brought into contact with a portion of the base material, and then portions away therefrom are sequentially pressed against the base material or the vacuum suction mold on the skin side.

At this time, with respect to the portion of the resin sheet material which has been brought into contact with and secured to the base material first, the portions successively away therefrom are sequentially secured to the base material while being stretched. This results in unevenness in the thickness of the resin sheet material and causes of deterioration of the quality of the instrument panel.

In view of the conventional technical problem, it is an object of the present invention to provide a resin molding method and a resin molding device capable of preventing drawdown of a resin sheet material as much as possible, and to provide a resin molding method and a resin molding device capable of preventing unevenness in the thickness of the resin sheet material as much as possible.

### Solution to Problem

A resin molding method according to a first aspect of the invention comprises: a holding step of holding a resin sheet material in a state of being stretched in a longitudinal direction by gripping ends in the longitudinal direction of the resin sheet material and ends in a transverse direction thereof by a gripping unit; a heating step of heating and softening the resin sheet material held in the holding step; a stretching step of stretching the resin sheet material softened in the heating step by pulling the resin sheet material in the longitudinal direction and the transverse direction through the gripping unit; and a molding step of forming the resin sheet material stretched in the stretching step by vacuum forming or pressure forming.

In such a resin molding method, when the resin sheet material held by gripping the ends in the longitudinal direction and the ends in the transverse direction in the holding step is heated in the heating step, drawdown that is sagging down of the resin sheet material occurs. Conventionally, since the drawdown is large, there is a possibility of occurrence of wrinkles or tears in the resin sheet material during the molding process.

In this respect, according to the first aspect of the invention, since the resin sheet material which has already been stretched in the longitudinal direction is held in the holding step and heated in the heating step, it is possible to reduce the occurrence of drawdown of the resin sheet material in the heating step as much as possible. Consequently, wrinkles and tears of the resin sheet material due to drawdown are prevented, and the productivity is improved.

In a second aspect of the invention according to the first aspect of the invention, the stretching step comprises: a first stretching step of stretching the resin sheet material softened in the heating step in the longitudinal direction thereof, and a second stretching step of, while securing end portions in the longitudinal direction corresponding to a formed part of the resin sheet material softened in the heating step, pulling the ends in the transverse direction of the resin sheet material and thereby stretching both sides of the formed part in the transverse direction.

According to the second aspect of the invention, in the second stretching step, when the ends in the transverse direction of the resin sheet material are pulled while securing the ends in the longitudinal direction corresponding to the formed part of the resin sheet material, the formed part of the resin sheet material is not stretched much and only both sides of the formed part in the transverse direction are stretched. Therefore, while stretching the resin sheet material to a desired size by the stretching step, it is possible to restrict an increase in the stretch ratio in the transverse direction of the formed part of the resin sheet material and to reduce unevenness in the thickness of the formed part. Consequently, the quality of molding of the resin sheet material is improved.

In a resin molding method of a third aspect of the invention according to the first aspect of the invention, the gripping unit is constituted by a plurality of clamps; the method includes a bending step of bending the resin sheet material softened in the heating step in at least one direction by moving a part or all of the plurality of clamps so that a shape of the resin sheet material approximates to a shape of a mold or a base material; and the molding step brings the resin sheet material bent in the bending step into close contact with the mold or the base material while holding the resin sheet material with the clamps, and forms the resin sheet material as a single part or a skin of the base material.

In such a resin molding method, when bringing the resin sheet material into close contact with the mold or the base material while gripping and holding the resin sheet material with a plurality of clamps, the resin sheet material is conventionally in a planar state. In this case, with a portion of the resin sheet material which first comes into contact with the mold or the base material as the starting point, portions of the resin sheet material which successively come into contact with the mold or the base material thereafter are stretched. This will results in unevenness in the thickness of the resin sheet material after being formed, and cause deterioration of the quality of molding.

In this respect, in the third aspect of the invention, the resin sheet material is bent before being brought into close contact with the mold or the base material so that the shape thereof approximates the shape of the mold or the base material. Therefore, it is possible to bring the respective portions of the resin sheet material into close contact with the mold or the base material at the same time as much as possible. Consequently, unevenness in thickness of the resin sheet material is prevented as much as possible, and the quality of molding is improved and the productivity is increased.

A resin molding method according to a fourth aspect of the invention comprises: a holding step of holding a resin sheet material by gripping a peripheral portion thereof with a plurality of clamps; a heating step of heating and softening the resin sheet material held in the holding step; a bending step of bending the resin sheet material softened in the heating step in at least one direction by moving a part or all of the plurality of clamps so that a shape of the resin sheet material approximates to a shape of a mold or a base material; and a molding step of bringing the resin sheet material bent in the bending step into close contact with the mold or the base material while holding the resin sheet material with the clamps, and vacuum forming or pressure forming the resin sheet material as a single part or as a skin of the base material.

According to the fourth aspect of the invention, similarly to the case of the third aspect of the invention, the respective portions of the resin sheet material can be brought into close contact with the mold or the base material at the same time as much as possible. Hence, it is possible to prevent unevenness in the thickness of the resin sheet material as much as possible.

A resin molding device according to a fifth aspect of the invention comprises: a unit which obtains a resin sheet material in a state of being stretched in a longitudinal direction; a stretching mechanism which holds the resin sheet material obtained by the unit by gripping ends in the longitudinal direction of the resin sheet material and ends in a transverse direction thereof, and pulls and stretches the resin sheet material in the longitudinal direction and the transverse direction; a heating unit which heats and softens the resin sheet material held by the stretching mechanism; and a resin molding unit which forms the resin sheet material softened by the heating unit and stretched and held by the stretching mechanism by vacuum forming or pressure forming.

According to the fifth aspect of the invention, similarly to the case of the first aspect of the invention, since the resin sheet material which has already been stretched in the longitudinal direction is heated by the heating unit, it is possible to prevent as much as possible a drawdown from being caused in the resin sheet material in heating with the heating unit.

In a sixth aspect of the invention according to the fifth aspect of the invention, the stretching mechanism comprises: a first stretching mechanism which stretches the resin sheet material softened by the heating unit in the longitudinal direction thereof, and a second stretching mechanism which, while securing ends in the longitudinal direction corresponding to a formed part of the resin sheet material softened by the heating unit, pulls the ends in the transverse direction of the resin sheet material and thereby stretches both sides of the formed part in the transverse direction.

According to the sixth aspect of the invention, similarly to the case of the second aspect of the invention, the second stretching mechanism can stretch only both sides of the formed part in the transverse direction without much stretching the formed part of the resin sheet material. Therefore, similarly to the case of the second aspect of the invention, it is possible to reduce unevenness in the thickness of the formed part while ensuring a desired size of the resin sheet material.

In a resin molding device of a seventh aspect of the invention according to the fifth aspect of the invention, gripping of the resin sheet material by the stretching mechanism is performed with a plurality of damps; the device comprises a bending mechanism which bends the resin sheet material held by the stretching mechanism in at least one direction by moving a part or all of the plurality of clamps so that a shape of the resin sheet material approximates to the shape of a mold or a base material; and the resin molding unit brings the resin sheet material bent by the bending mechanism into close contact with the mold or the base material, and forms the resin sheet material as a single part or as a skin of the base material.

According to the seventh aspect of the invention, similarly to the case of the third aspect of the invention, since the resin sheet material is bent before being brought into close contact with the mold or the base material so that the resin sheet material has a shape approximate to the shape of the mold or the base material, it is possible to prevent the occurrence of unevenness in the thickness of the resin sheet material as much as possible.

A resin molding device according to an eighth aspect of the invention comprises: a plurality of clamps which hold a resin sheet material by gripping a peripheral portion of the resin sheet material; a heating unit for heating and softening the resin sheet material held by the plurality of clamps; a bending mechanism which bends the resin sheet material softened by the heating unit in at least one direction by moving a part or all of the plurality of clamps so that a shape of the resin sheet material approximates to a shape of a mold or a base material; and a molding mechanism which brings the resin sheet material bent by the bending mechanism into close contact with the mold or the base material while holding the resin sheet material with the damps, and vacuum forms or pressure forms the resin sheet material as a single part or as a skin of the base material.

According to the eighth aspect of the invention, similarly to the case of the seventh aspect of the invention, since the resin sheet material is bent before being brought into close contact with the mold or the base material so that the resin sheet material has a shape approximate to the shape of the mold or the base material, it is possible to prevent the occurrence of unevenness in the thickness of the resin sheet material as much as possible.

### BRIEF DESCRIPTION OF DRAWINGS

FIG. 1 is a schematic diagram showing the configuration of a resin molding device according to one embodiment of the present invention.

FIG. 2 is a perspective view showing a state in which a resin sheet material is held by a stretching and bending mechanism of the resin molding device of FIG. 1 and is not yet stretched.

FIG. 3 is a perspective view showing a state in which the resin sheet material is held and stretched in a longitudinal direction by the stretching and bending mechanism of the resin molding device of FIG. 1.

FIG. 4 is a perspective view showing a state in which the resin sheet material is held and stretched in the longitudinal direction and transverse direction by the stretching and bending mechanism of the resin molding device of FIG. 1.

FIG. 5 is a perspective view showing a state in which after the resin sheet material is held and stretched in the longitudinal direction and transverse direction by the stretching and bending mechanism of the resin molding device of FIG. 1, the resin sheet material is bent.

FIG. 6 is a cross-sectional view showing a state immediately before the resin sheet material bent by the stretching and bending mechanism of the resin forming apparatus of FIG. 1 is sandwiched between a base material on a lower die and an upper die, and clamped.

FIG. 7 is a perspective view showing a state in which the base material of an instrument panel is mounted on the lower die of the resin molding device of FIG. 1.

### DESCRIPTION OF EMBODIMENT

The following will describe an embodiment of the present invention with reference to the drawings. A resin molding device of this embodiment has a function of forming a resin sheet material and attaching the resin sheet material to a base material of an instrument panel of an automobile as a skin.

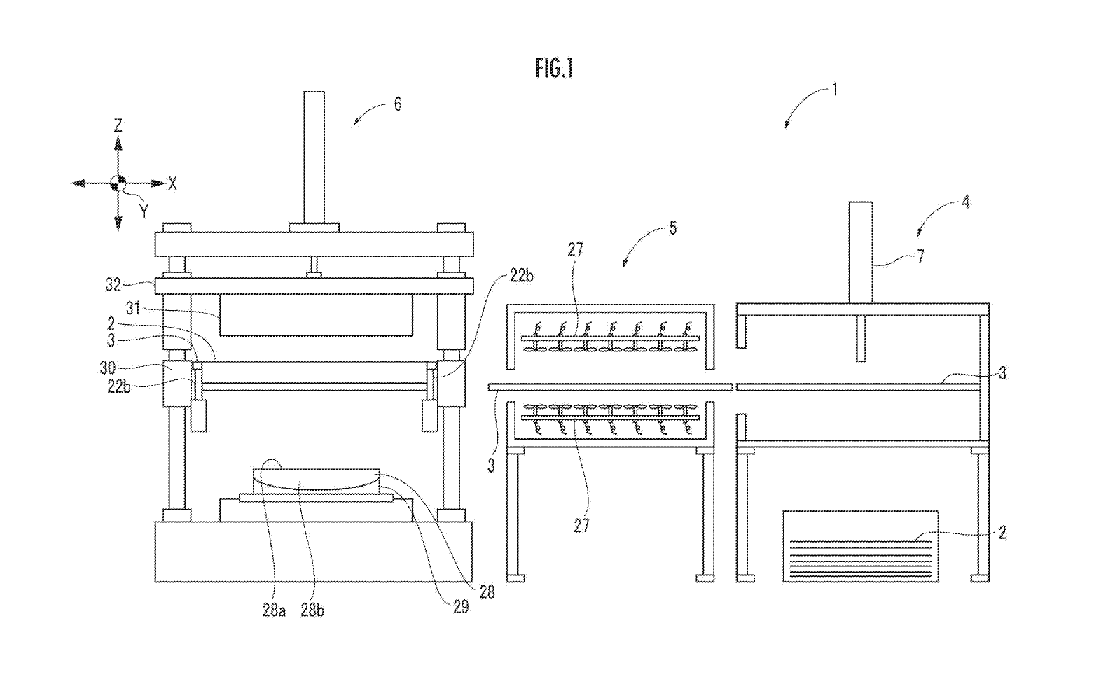

As shown in FIG. 1, this resin molding device 1 includes: a stretching and bending mechanism 3 which holds, stretches and bends a resin sheet material 2; a sheet supply unit 4 which supplies the resin sheet material 2 to the stretching and bending mechanism 3; a heating unit 5 which heats and softens the resin sheet material 2 held by the stretching and bending mechanism 3; and a resin molding unit 6 which vacuum forms the resin sheet material 2 softened by the heating unit 5 and held by the stretching and bending mechanism 3.

In the resin molding unit 6, the formed resin sheet material 2 is attached to a base material 28 of the instrument panel as a skin. The stretching and bending mechanism 3 is sequentially moved to the heating unit 5 and the resin molding unit 6 while holding the resin sheet material 2 supplied by the sheet supply unit 4, and is moved back to the sheet supply unit 4 after completing the process in the resin molding unit 6.

As the resin sheet material 2, it is possible to use a material suitable for the skin of the instrument panel, for example, one obtained by bonding a foamed layer of polypropylene foam to a thin film of thermoplastic olefin. The resin sheet material 2 has a rectangular shape corresponding to the skin of the instrument panel.

The resin sheet material 2 is obtained by cutting a resin sheet raw material rolled while being pulled in the winding direction for each longitudinal dimension of the resin sheet material 2 and cutting it at the center in a transverse direction of the resin sheet raw material. Thus, the resin sheet material 2 has already been stretched in the longitudinal direction when the resin sheet raw material is rolled. In other words, an apparatus for rolling the resin sheet raw material while pulling in the winding direction and an apparatus for cutting the resin sheet raw material function as a unit which obtains the resin sheet material 2 in a state of being stretched in the longitudinal direction.

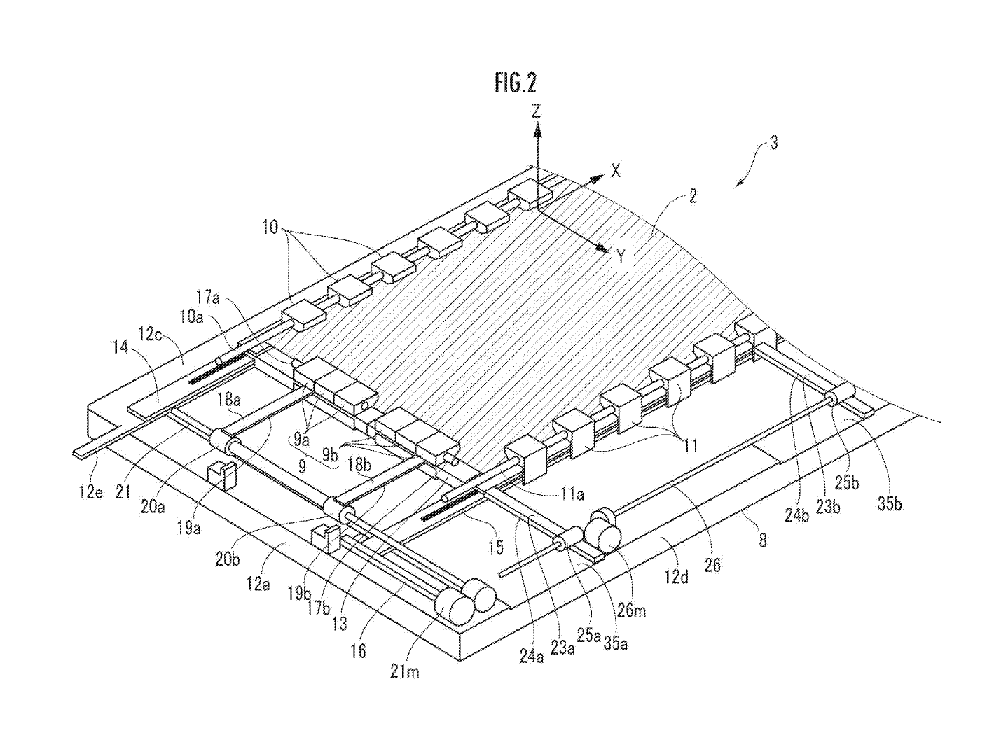

The sheet supply unit 4 includes a sheet delivery mechanism 7 which grips one sheet of the resin sheet material 2 stacked in a lower section of the sheet supply unit 4, and delivers the sheet to the stretching and bending mechanism 3. The stretching and bending mechanism 3 has a substantially rectangular shape, and has a symmetrical structure about the YZ-plane when a direction along the longitudinal direction is the X-axis direction, a direction along the transverse direction is the Y-axis direction, and X-, Y- and Z-axes are defined as shown in FIG. 2. FIG. 2 shows a half of the structure, on the negative side of the X-axis.

As shown in FIG. 2, the stretching and bending mechanism 3 includes a rectangular frame body 8, a plurality of first clamps 9 which grip the ends on both sides in the longitudinal direction of the resin sheet material 2, a plurality of second clamps 10 which grip the end on one side in the transverse direction of the resin sheet material 2, and a plurality of third clamps 11 which grip the end on the other side in the transverse direction of the resin sheet material 2.

A gripping unit which grips a peripheral portion of the resin sheet material 2 is constituted by the first to third clamps 9, 10, 11. The frame body 8 includes a side member 12a on the negative X-axis side and a side member 12b, not shown, on the positive X-axis side parallel to the Y-axis, and a side member 12c on the negative Y-axis side and a side member 12d on the positive Y-axis side parallel to the X-axis.

A plurality of first clamps 9 on the negative X-axis side which grip one of the ends in the longitudinal direction of the resin sheet material 2 are supported to be movable in parallel with the Y-axis by a first guide 13 on the negative X-axis side provided parallel to the Y-axis. A plurality of first clamps 9 on the positive X-axis side which grip the other end in the longitudinal direction of the resin sheet material 2 are supported in the same manner by a similar first guide 13 on the positive X-axis side.

The second clamps 10 are supported to be movable in parallel with the X-axis by a second guide 14 provided parallel to the X-axis, and are opened and closed by turning a second opening and closing shaft 10a in one direction and the other direction. The third clamps 11 are supported to be movable in parallel with the X-axis by a third guide 15 provided parallel to the X-axis, and are opened and closed by turning a third opening and closing shaft 11a in one direction and the other direction.

The end on the negative Y-axis side of each first guide 13 is supported by the second guide 14 to be freely movable in the X-axis direction, and the end on the positive Y-axis side is supported by the third guide 15 to be freely movable in the X-axis direction.

The second guide 14 is fixed to the upper surface of the side member 12c of the frame body 8. On each of the side members 12a and 12b (not shown) of the frame body 8, a fourth guide 16 is provided from a position, which is slightly off-center to the side member 12d, toward the end on the side member 12d side. Both ends of the third guide 15 are supported by the fourth guides 16 of the side members 12a and 12b, respectively, so as to be freely movable in the Y-axis direction.

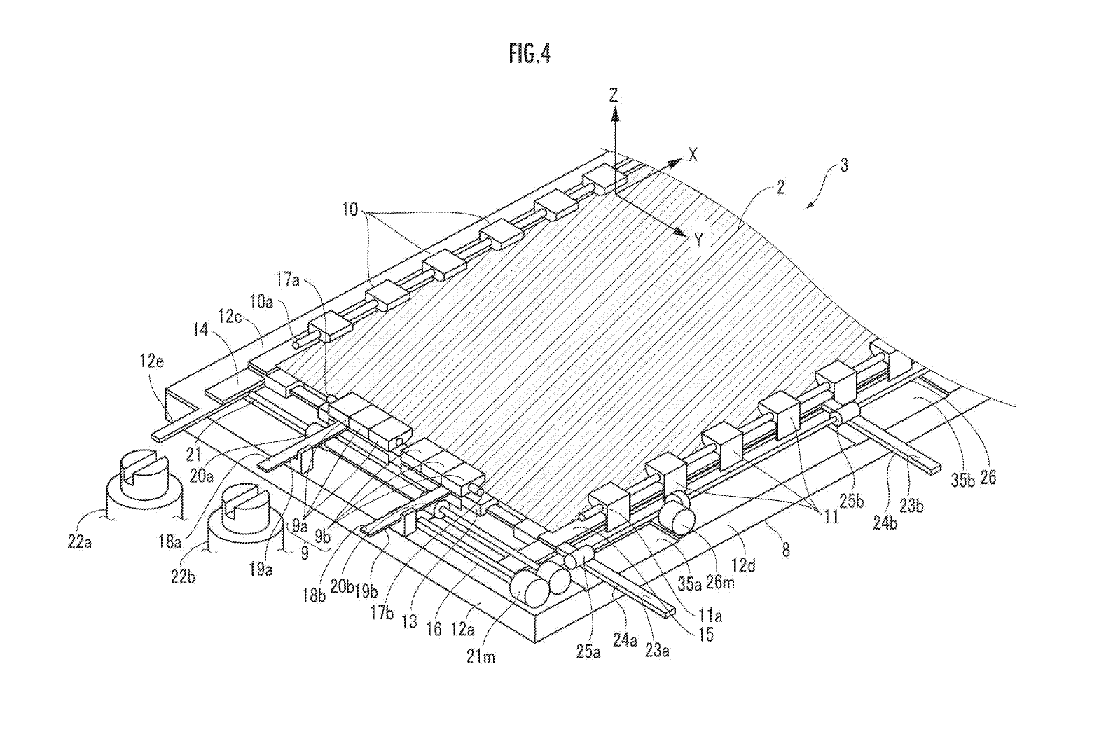

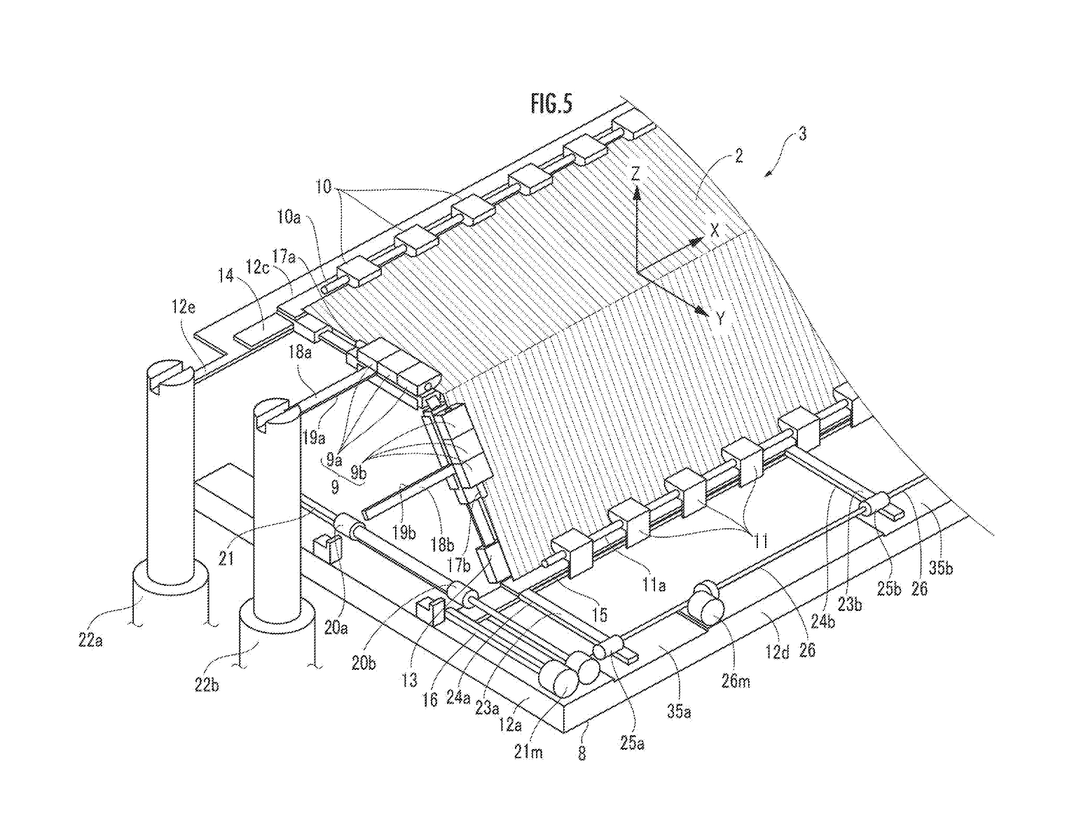

Each of the first guides 13 is configured to be freely extendable and retractable between substantially the length in the transverse direction of the resin sheet material 2 before being stretched as in FIG. 2 and the length in the transverse direction of the resin sheet material 2 after being stretched as in FIG. 4. In addition, each of the first guides 13 is configured so that the first guide 13 in a state of being stretched as in FIG. 4 can be bent at the center point as shown in FIG. 5.

The first clamps 9a, which are a half on the side member 12c side of the first clamps 9 on the negative X-axis side, are fixed to each other and configured to be opened and closed by turning a common first opening and closing shaft 17a along the transverse direction of the frame body 8 in one direction or the other direction. The first clamps 9b, which are a half on the side member 12d side of the first clamps 9 on the negative X-axis side, are fixed to each other and configured to be opened and closed in the same manner by a common first opening and closing shaft 17b along the transverse direction of the frame body 8.

The first clamps 9a and 9b are connected to each other so as to be movable on the first guide 13 in a state in which their positions are fixed, and so as not to hinder the above-described bending of the first guide 13. The first clamps 9 on the positive X-axis side (the side member 12b side) (not shown) are also constituted by the similar first clamps 9a and 9b and configured to be opened and closed by the first opening and closing shafts 17a and 17b.

The first clamps 9a and 9b on the negative X-axis side are fixed to one ends of two traction rods 18a and 18b, respectively. The traction rods 18a and 18b extend from the one end side to the negative X-axis direction, and have racks 19a and 19b along the X-axis, respectively.

The first clamps 9a and the first clamps 9b are guided by the second guide 14 and the third guide 15 together with the first guide 13 through pinions 20a and 20b engaged with the respective racks 19a and 19b, and driven in the X-axis direction.

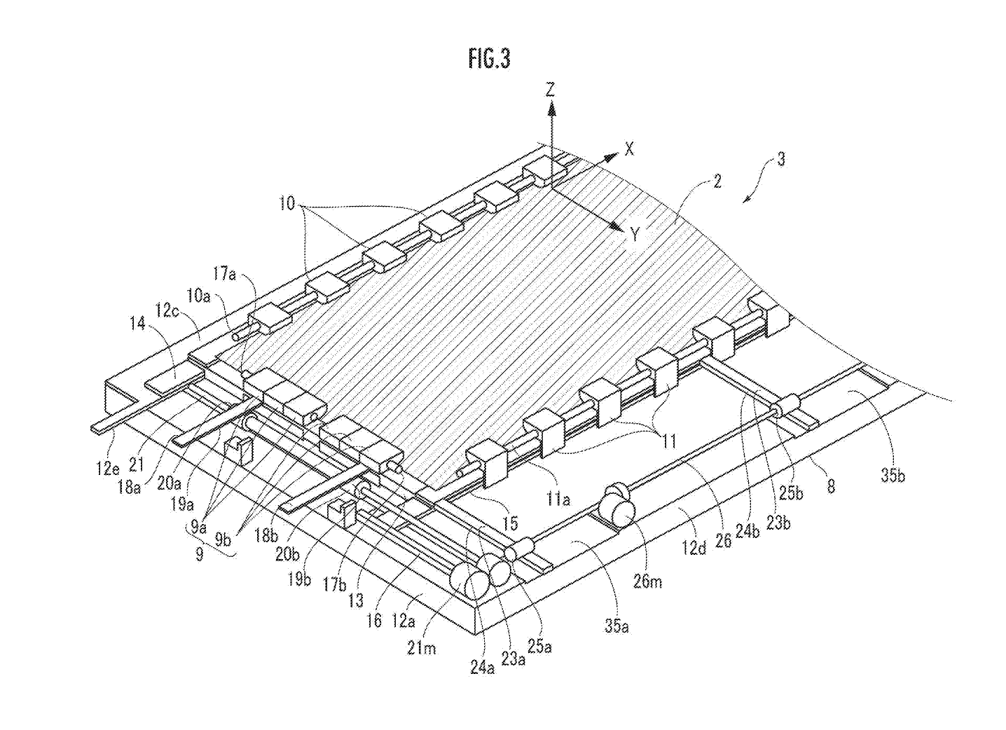

The pinions 20a and 20b are mounted on a drive shaft 21 and driven by turning the drive shaft 21 with a motor 21m, and, as shown in FIG. 3 and FIG. 4, are movable with the movement of the traction rods 18a and 18b in the Y-axis direction.

The side member 12c is formed of a thin plate member in the Z-axis direction, and an end thereof on the side intersecting the side member 12a is placed over the side member 12a. A pulling rod 12e extends from the end toward the negative X-axis direction. As shown in FIG. 4 and FIG. 5, the pulling rod 12e and the end of the traction rod 18a on the negative X-axis direction side when moved in the negative X-axis direction can be driven in the Z-axis direction by drive cylinders 22a and 22b, respectively.

Provided on the negative X-axis side of the third guide 15 are traction rods 24a and 24b whose one ends are guided by the third guide 15 to be freely movable in the X-axis direction. The traction rods 24a and 24b extend in the positive Y-axis direction and have racks 23a and 23b, respectively, extending in the Y-axis direction.

The other ends of the traction rods 24a and 24b are supported by recesses 35a and 35b provided on the side member 12d so as to be movable in the X-axis direction and the Y-axis direction, respectively. The end of the traction rod 24a on the side guided by the third guide 15 is connected to the end of the first guide 13 so that the traction rod 24a moves together with the first guide 13 in the X-axis direction.

Provided on the negative X-axis side of the side member 12d is a drive shaft 26 having two pinions 25a and 25b engaged with the racks 23a and 23b of the traction rods 24a and 24b, respectively. Provided on the side member 12d is a motor 26m for turning the drive shaft 26 and moving the third guide 15 in the Y-axis direction through the pinions 25a and 25b and the traction rods 24a and 24b. The two pinions 25a and 25b are configured to move in the X-axis direction as the traction rods 24a and 24b move in the X-axis direction.

As described above, the stretching and bending mechanism 3 has a symmetrical structure about the YZ-plane, and the above-described respective elements in FIG. 2 to FIG. 5 are also present symmetrically on the positive X-axis side, not shown.

As shown in FIG. 1, the heating unit 5 includes a heater 27 which heats from both front and back sides and softens the resin sheet material 2 supplied to the stretching and bending mechanism 3 by the sheet supply unit 4 and held by the stretching and bending mechanism 3 moved in the negative X-axis direction from the sheet supply unit 4.

The resin molding unit 6 includes: a lower die 29 on which the base material 28 of the instrument panel is mounted, a first elevating mechanism 30 which raises and lowers the stretching and bending mechanism 3 moved in the negative X-axis direction from the heating unit 5; an upper die 31 for vacuum forming the resin sheet material 2 held by the stretching and bending mechanism 3; and a second elevating mechanism 32 which raises and lowers the upper die 31. As shown in FIG. 7, with respect to a portion 28a of the base material 28 mounted on the lower die 29, other portion 28b thereof is bent at an angle as indicated by a dash and dotted line 33.

Note that the positive X-axis direction of the stretching and bending mechanism 3 in FIG. 1 corresponds to the right direction in the drawing, the positive Y-axis direction corresponds to the front direction in the drawing, the positive Z-axis direction corresponds to the upward direction in the drawing, and FIG. 1 and FIG. 7 show the X, Y and Z directions along the X-, Y- and Z-axes.

In this configuration, when forming a single sheet of resin sheet material 2 and attaching the resin sheet material 2 as a skin to the base material 28 of the instrument panel, first, a holding step of holding the resin sheet material 2 by gripping the ends in the longitudinal direction of the resin sheet material 2 and the ends in the transverse direction thereof is performed.

Specifically, in the sheet supply unit 4, the topmost sheet of the resin sheet material 2 stocked in the lower section of the sheet supply unit 4 is gripped by the sheet delivery mechanism 7, delivered to the stretching and bending mechanism 3, and gripped by the stretching and bending mechanism 3. This resin sheet material 2 is in a state of being stretched in the longitudinal direction. Precisely, as described above, the resin sheet material 2 is obtained by cutting the resin sheet raw material so that the longitudinal direction of the resin sheet material 2 coincides with the longitudinal direction of the resin sheet raw material rolled while being pulled in the winding direction.

When delivering the resin sheet material 2 from the sheet delivery mechanism 7 to the stretching and bending mechanism 3, in the stretching and bending mechanism 3, the first guides 13, the third guide 15, the first clamps 9, the second clamps 10, the third clamps 11, etc. are driven in conjunction with the sheet delivery mechanism 7, and the delivery of the resin sheet material 2 is carried out smoothly. FIG. 2 shows a state in which the delivery is completed and the stretching and bending mechanism 3 holds the resin sheet material 2 by gripping the ends in the longitudinal direction of the resin sheet material 2 and the ends in the transverse direction.

Next, a heating step is started. In the heating step, the stretching and bending mechanism 3 is moved from the sheet supply unit 4 to the heating unit 5, and the resin sheet material 2 gripped by the stretching and bending mechanism 3 is heated and softened by the heater 27.

In the heating unit 5, when the resin sheet material 2 reaches a predetermined softening temperature and softens, a stretching step of stretching the resin sheet material 2 in the longitudinal direction and the transverse direction is performed. Specifically, a first stretching step of stretching the resin sheet material 2 in the longitudinal direction is performed first. At this time, the stretching and bending mechanism 3 functions as a first stretching mechanism.

The first stretching step is carried out by moving the first guides 13 on the X-axis negative side and positive side in the negative and positive X-axis directions, respectively, to the ends of the second guide 14 and the third guide 15 by the motor 21m through the pinions 20a, 20b and the racks 19a, 19b.

Meanwhile, the second clamps 10 and the third clamps 11 gripping the respective ends in the transverse direction of the resin sheet material 2 move on the second guide 14 and the third guide 15, respectively, as the gripped portions move with the stretching of the resin sheet material 2 in the longitudinal direction. Therefore, the mutual distance between the second clamps 10 and the mutual distance between the third clamps 11 are slightly increased.

Each of the traction rods 24a and 24b also moves into the direction of the corresponding end of the third guide 15 along each first guide 13. FIG. 3 shows a state in which the stretching of the resin sheet material 2 in the longitudinal direction is completed.

Next, a second stretching step of stretching the resin sheet material 2 in the transverse direction is performed. At this time, the stretching and bending mechanism 3 functions as a second stretching mechanism. The stretching in the second stretching step is carried out by moving the third guide 15 to the vicinity of the side member 12d by the motor 26m through the pinions 25a, 25b and the racks 23a, 23b. Thus, the resin sheet material 2 changes from the state before being stretched in the transverse direction in FIG. 3 into the state of being stretched in the transverse direction in FIG. 4.

Along with this stretching in the transverse direction, the respective first clamps 9 gripping both ends in the longitudinal direction of the resin sheet material 2 move according to the gripped positions as the gripped positions move in the transverse direction. Therefore, during the change from the state shown in FIG. 3 into the state shown in FIG. 4, the first clamps 9 continue to grip the same central portion in both the ends in the longitudinal direction of the resin sheet material 2, excluding both ends in the transverse direction.

The central portion that continues to be gripped by each of the first clamps 9 is a portion which corresponds to a formed part of the resin sheet material 2 in the transverse direction. The formed part is a portion of the resin sheet material 2 which is formed and used as the skin of the instrument panel. Thus, the stretching of the resin sheet material 2 in the transverse direction is carried out only for the portions on both sides of the formed part in the transverse direction, and stretching is limited as much as possible for the formed part.

When the stretching step is completed in such a manner, next, a bending step is performed to bend the resin sheet material 2 into a shape suitable for the base material of the instrument panel. The bending step is carried out while the resin sheet material 2 has a temperature equal to or higher than a predetermined softening temperature.

As shown in FIG. 4 and FIG. 5, the bending of the resin sheet material 2 is carried out by driving the pulling rod 12e and the traction rod 18a in the positive Z-axis direction by the drive cylinders 22a and 22b and moving the third guide 15 in the negative Y-axis direction in correspondence with the driving of the pulling rod 12e and the traction rod 18a. At this time, the side member 12c moves in the positive Z-axis direction together with the pulling rod 12e.

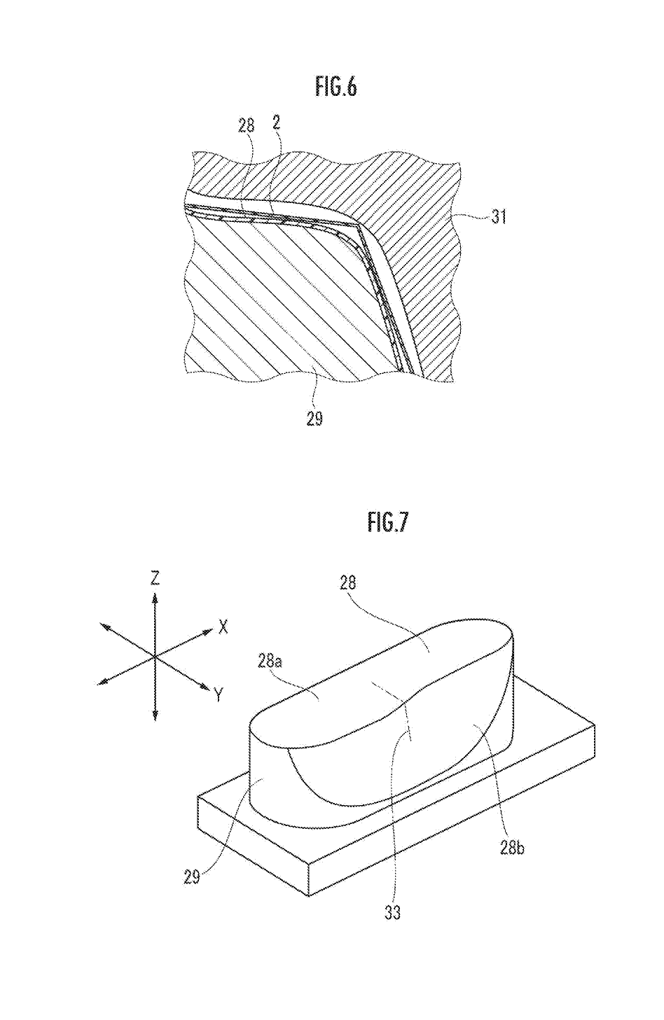

Consequently, as shown in FIG. 5, each of the first guides 13 is bent at the midpoint in a plane parallel to the YZ-plane. Accordingly, the resin sheet material 2 gripped by the first clamps 9a and 9b on both sides of the midpoint on each first guide 13 is also bent. Hence, the resin sheet material 2 has a shape approximate to the base material 28 of the instrument panel as shown in FIG. 6.

Next, clamping is performed by lowering the stretching and bending mechanism 3 by the first elevating mechanism 30 with respect to the lower die 29 on which the base material 28 is mounted and lowering the upper die 31 by the second elevating mechanism 32 so that the upper die 31 reaches the lower die 29 at substantially the same time as the resin sheet material 2 reaches the base material 28. Consequently, the resin sheet material 2 adheres closely to the base material 28.

At this time, as shown in FIG. 6, the resin sheet material 2 is bent as described above and has a shape following as much as possible the shape of the base material 28. Therefore, compared to the case where the resin sheet material 2 is flat, the quantity of the resin sheet material 2 stretched in the lowering direction of the upper die 31 with the corners of the base material 28 as the starting point by the upper die 31 is smaller.

After clamping, vacuum forming of the resin sheet material 2 is carried out by applying a vacuum suction from the upper die 31 side to perform a molding step of forming embossment, etc. on the surface of the resin sheet material 2. Thereafter, a vacuum suction is applied from the lower die 29 side to stick the back surface of the resin sheet material 2 to the base material 28, whereby the resin sheet material 2 is bonded to the base material 28 with a thermo-fusible adhesive applied in advance to the back surface.

Thereafter, the upper die 31 is raised and opened, a joined product produced by bonding the resin sheet material 2 and the base material 28 together is removed, and an unneeded part of the resin sheet material 2 is cut off, whereby an instrument panel constituted by the base material 28 and the skin is obtained.

According to this embodiment, by subjecting the resin sheet material 2 stretched in the longitudinal direction beforehand to the heating step, it is possible to avoid as much as possible drawdown from being caused in the resin sheet material 2 in the heating step and to prevent wrinkles and tears of the resin sheet material 2 due to drawdown.

Moreover, in the second stretching step, since the ends in the transverse direction of the resin sheet material 2 are pulled while securing ends in the longitudinal direction of the resin sheet material 2 corresponding to the formed part of the resin sheet material 2 with the first clamps 9, it is possible to stretch only both sides of the formed part in the transverse direction without much stretching the formed part of the resin sheet material 2.

Therefore, while ensuring a desired size of the resin sheet material 2 by the stretching step, an increase in the stretch ratio in the transverse direction of the formed part of the resin sheet material 2 is reduced, and unevenness in the thickness of the formed part is decreased. Consequently, it is possible to improve the quality of molding of the resin sheet material 2.

Furthermore, since the resin sheet material 2 stretched in the stretching step is bent along the base material 28 of the instrument panel in the bending step, it is possible to approximate the timings in which the resin sheet material 2 comes into contact with the upper die 31 and the base material 28 when pressing the resin sheet material 2 against the upper die 31 and the base material 28 by clamping. This makes it possible to reduce the quantity of stretching of the resin sheet material 2 at the time of clamping, equalize the thickness of the resin sheet material 2, increase the yield, and improve the productivity of the instrument panel.

The embodiment of the present invention has been described above, but it does not limit the invention. For example, the present invention is not limited to the case where the resin sheet material 2 is formed as a skin to be attached to the base material 28, but can also be applied to the case where the resin sheet material is formed as a single part. The forming of the resin sheet material 2 may also be performed by pressure forming. Moreover, the stretching step and the bending step may also be performed in parallel with the heating step.

After the resin sheet material 2 is softened, the stretching step may be performed in any timing while the stretching and bending mechanism 3 is positioned in the heating unit 5, while the stretching and bending mechanism 3 is being moved from the heating unit 5 to the resin molding unit 6, or after the stretching and bending mechanism 3 is moved to the resin molding unit 6.

In the case where the resin sheet material 2 is obtained by cutting the resin sheet raw material wound into a roll so that its longitudinal direction is the transverse direction of the resin sheet material 2, the resin sheet material 2 obtained by cutting may be stretched in the longitudinal direction by a stretching mechanism like the stretching and bending mechanism 3 before being supplied to the heating unit 5 or the sheet supply unit 4. This stretching mechanism constitutes a unit which obtains a resin sheet material in a state of being stretched in the longitudinal direction similarly to the above-described apparatus which rolls the resin sheet raw material while pulling in the winding direction.

When bending the resin sheet material 2 in the bending step, in addition to bending in one direction as shown in FIG. 5, the resin sheet material 2 may also be bent in the opposite direction or another direction. When bending the resin sheet material 2 in the bending step, bending may be performed by moving only a part of the first clamps 9, the second clamps 10 and the third clamps 11.

### REFERENCE SIGNS LIST

1 resin molding device
2 resin sheet material
3 stretching and bending mechanism
4 sheet supply unit
5 heating unit
6 resin molding unit
7 sheet delivery mechanism
8 frame body
9 (9a, 9b) first clamp
10 second clamp
11 third clamp
12a-12d side member
12e pulling rod
13 first guide
14 second guide
15 third guide
16 fourth guide
17a, 17b first opening and closing shaft
18a, 18b traction rod
19a, 19b rack
20a, 20b pinion
21 drive shaft
21m motor
22a, 22b drive cylinder
23a, 23b rack
24a, 24b traction rod
25a, 25b pinion
26 drive shaft
26m motor
27 heater
28 base material
29 lower die (mold)
30 first elevating mechanism
31 upper die (mold)
32 second elevating mechanism.

1. A resin molding method comprising:
a holding step of holding a resin sheet material in a state of being stretched in a longitudinal direction by gripping ends in the longitudinal direction of the resin sheet material and ends in a transverse direction thereof by a gripping unit;
a heating step of heating and softening the resin sheet material held in the holding step;
a stretching step of pulling and stretching the resin sheet material softened in the heating step in the longitudinal direction and the transverse direction through the gripping unit; and
a molding step of forming the resin sheet material stretched in the stretching step by vacuum forming or pressure forming.

2. The resin molding method according to claim 1, wherein the stretching step comprises:
a first stretching step of stretching the resin sheet material softened in the heating step in the longitudinal direction thereof; and
a second stretching step of, while securing ends in the longitudinal direction corresponding to a formed part of the resin sheet material softened in the heating step, pulling the ends in the transverse direction of the resin sheet material and thereby stretching both sides of the formed part in the transverse direction.

3. The resin molding method according to claim 1, wherein
the gripping unit is constituted by a plurality of clamps,
the method comprises a bending step of bending the resin sheet material softened in the heating step in at least one direction by moving a part or all of the plurality of clamps so that a shape of the resin sheet material approximates to a shape of a mold or a base material, and
the molding step brings the resin sheet material bent in the bending step into close contact with the mold or the base material while holding the resin sheet material with the clamps, and forms the resin sheet material as a single part or a skin of the base material.

4. A resin molding method comprising:
a holding step of holding a resin sheet material by gripping a peripheral portion thereof with a plurality of clamps;
a heating step of heating and softening the resin sheet material held in the holding step;
a bending step of bending the resin sheet material softened in the heating step in at least one direction by moving a part or all of the plurality of clamps so that a shape of the resin sheet material approximates to a shape of a mold or a base material; and
a molding step of bringing the resin sheet material bent in the bending step into close contact with the mold or the base material while holding the resin sheet material with the clamps, and vacuum forming or pressure forming the resin sheet material as a single part or as a skin of the base material.

5. A resin molding device comprising:
a unit which obtains a resin sheet material in a state of being stretched in a longitudinal direction;
a stretching mechanism which holds the resin sheet material obtained by the unit by gripping ends in the longitudinal direction of the resin sheet material and ends in a transverse direction thereof, and pulls and stretches the resin sheet material in the longitudinal direction and the transverse direction;
a heating unit which heats and softens the resin sheet material held by the stretching mechanism; and
a resin molding unit which forms the resin sheet material softened by the heating unit and stretched and held by the stretching mechanism by vacuum forming or pressure forming.

6. The resin molding device according to claim 5, wherein the stretching mechanism comprises:
a first stretching mechanism which stretches the resin sheet material softened by the heating unit in the longitudinal direction thereof; and
a second stretching mechanism which, while securing ends in the longitudinal direction corresponding to a formed part of the resin sheet material softened by the heating unit, pulls the ends in the transverse direction of the resin sheet material and thereby stretches both sides of the formed part in the transverse direction.

7. The resin molding device according to claim 5, wherein
gripping of the resin sheet material by the stretching mechanism is performed with a plurality of clamps,
the device comprises a bending mechanism which bends the resin sheet material held by the stretching mechanism in at least one direction by moving a part or all of the plurality of clamps so that a shape of the resin sheet material approximates to a shape of a mold or a base material, and
the resin molding unit brings the resin sheet material bent by the bending mechanism into close contact with the mold or the base material, and forms the resin sheet material as a single part or as a skin of the base material.

8. A resin molding device comprising:
a plurality of clamps which hold a resin sheet material by gripping a peripheral portion of the resin sheet material;
a heating unit for heating and softening the resin sheet material held by the plurality of clamps;
a bending mechanism which bends the resin sheet material softened by the heating unit in at least one direction by moving a part or all of the plurality of clamps so that a shape of the resin sheet material approximates to a shape of a mold or a base material; and
a molding unit which brings the resin sheet material bent in the bending mechanism into close contact with the mold or the base material while holding the resin sheet material with the clamps, and vacuum forms or pressure forms the resin sheet material as a single part or as a skin of the base material.
